(19) United States
(12) Patent Application Publication
(10) Pub. No.: US 2026/0347664 A1
(43) Pub. Date: Nov. 5, 2026

(54) ADHESIVE SEAM FILMS AND SEAMS FORMED THEREFROM

(71) Applicant: Avient Corporation, Avon Lake, OH (US)

(72) Inventors: Ketan SHAH, Gurnee, IL (US); Cesar CRUZ, Woodstock, IL (US); Zachary K. ZANDER, Lake Geneva, WI (US); William PEPE, Ringwood, IL (US)

(73) Assignee: Avient Corporation, Avon Lake, OH (US)

(21) Appl. No.: 19/484,076

(22) PCT Filed: May 16, 2024
(86) PCT No.: PCT/US2024/029621

§ 371 Date: Nov. 13, 2025

Related U.S. Application Data
(60) Provisional application No. 63/466,995, filed on May 16, 2023.
(60) Provisional application No. 63/645,832, filed on May 10, 2024.

(51) Int. Cl. C09J 7/35; C09J 5/06; C09J 7/21; C09J 11/08; D06H 5/00

(52) U.S. Cl. CPC C09J 7/35; C09J 5/06; C09J 7/21; C09J 11/08; D06H 5/00; C09J 2203/358; C09J 2301/408; C09J 2400/263; C09J 2400/266

(57) ABSTRACT

An adhesive seam film includes an adhesive film composition. The adhesive film composition includes, based on the total weight of the adhesive film composition, 21 wt % to 85 wt % of a styrene-ethylene/butylene-styrene triblock copolymer, 15 wt % to 35.5 wt % of a white mineral oil, and 0 wt % to 40 wt % tackifier. The styrene-ethylene/butylene-styrene triblock copolymer has a weight average molecular weight of 90,000 g/mol to 140,000 g/mol and a bound styrene content of 28 wt % to 35 wt %, based on the total weight of the styrene-ethylene/butylene-styrene triblock copolymer. The tackifier has a weight average molecular weight of 500 g/mol to 5000 g/mol, a glass transition temperature of 50 °C to 100 °C, and a softening temperature of 100 °C to 140 °C. The adhesive seam film has a thickness of 25 μm to 250 μm.

### CLAIM OF PRIORITY

This application claims the benefit of U.S. Provisional Patent Application Ser. No. 63/466,995 bearing Attorney Docket Number 1202306 and filed on May 16, 2023 and U.S. Provisional Patent Application Ser. No. 63/645,832 bearing Attorney Docket Number 1202402 and filed on May 10, 2024, which are all hereby incorporated by reference in their entirety.

### TECHNICAL FIELD

Embodiments of the present disclosure are generally related to adhesive seam films. More particularly, adhesive seam films include adhesive film compositions that include a styrene-ethylene/butylene-styrene triblock copolymer, a white mineral oil, and optionally a tackifier.

### BACKGROUND

Thermoplastic polyurethane compositions are commonly used in the apparel industry, such as in seamless adhesives, due to their desirable mechanical properties and durability. However, the use of thermoplastic polyurethane compositions may be cost prohibitive. Moreover, thermoplastic polyurethane compositions and other commonly used thermoplastic compositions may be in various forms, such as sprays or gels, that are difficult to work with and create unnecessary production delays.

Accordingly, a need exists for cost-effective thermoplastic compositions that may be formed into thin adhesive seam films.

### SUMMARY

Embodiments of the present disclosure are directed to adhesive seam films.

According to some embodiments, an adhesive seam film is provided. The adhesive seam film includes an adhesive film composition. The adhesive film composition includes, based on the total weight of the adhesive film composition, 21 weight percent (wt %) to 85 wt % of a styrene-ethylene/butylene-styrene triblock copolymer, 27 wt % to 35.5 wt % of a white mineral oil, and 0 wt % to 40 wt % of a tackifier. The styrene-ethylene/butylene-styrene triblock copolymer has a weight average molecular weight of 90,000 g/mol to 140,000 g/mol, and a bound styrene content of 15 wt % to 35 wt %, based on the total weight of the styrene-ethylene/butylene-styrene triblock copolymer. The tackifier has a weight average molecular weight of 500 g/mol to 5000 g/mol, a glass transition temperature of 50 °C to 100 °C, and a softening temperature of 100 °C to 140 °C. The adhesive seam film has a thickness of 25 μm to 250 μm.

According to some embodiments, a method of forming an adhesive seam film is provided. The method includes preparing an adhesive film composition and extruding the adhesive film composition to form an adhesive seam film that has a thickness of 25 μm to 250 μm. The adhesive film composition includes, based on the total weight of the adhesive film composition, 21 wt % to 85 wt % of a styrene-ethylene/butylene-styrene triblock copolymer, 15 wt % to 35.5 wt % of a white mineral oil, and 0 wt % to 40 wt % of a tackifier. The styrene-ethylene/butylene-styrene triblock copolymer has a weight average molecular weight of 90,000 g/mol to 140,000 g/mol and a bound styrene content of 28 wt % to 35 wt %, based on the total weight of the styrene-ethylene/butylene-styrene triblock copolymer. The tackifier has a weight average molecular weight of 500 g/mol to 5000 g/mol, a glass transition temperature of 50 °C to 100 °C, and a softening temperature of 100 °C to 140 °C.

According to other embodiments, a method of preparing a seam is provided. The method includes supplying a first section of fabric, a second section of fabric, and a film; situating the film between the first section of fabric and the second section of fabric to form a seam section; and heating the seam section such that the film adheres the first section of fabric and the second section of fabric. The second section of fabric at least partially overlaps the first section of fabric. The film includes a film composition. The film composition includes, based on a total weight of the film composition, 21 wt % to 85 wt % of a styrene-ethylene/butylene-styrene triblock copolymer, 15 wt % to 35.5 wt % of a white mineral oil, and 0 wt % to 40 wt % of a tackifier. The styrene-ethylene/butylene-styrene triblock copolymer has a weight average molecular weight of 90,000 g/mol to 140,000 g/mol and a bound styrene content of 28 wt % to 35 wt %, based on the total weight of the styrene-ethylene/butylene-styrene triblock copolymer. The tackifier has a weight average molecular weight of 500 g/mol to 5000 g/mol, a glass transition temperature of 50 °C to 100 °C, and a softening temperature of 100 °C to 140 °C. The adhesive seam film has a thickness of 25 μm to 250 μm.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 depicts an exemplary adhesive seam film, according to one or more embodiments shown and described herein;

FIG. 2 depicts an exemplary multilayer composite, according to one or more embodiments shown and described herein;

FIG. 3 depicts an exemplary multilayer composite with an adhesive seam film adhered to a fabric backing, according to one or more embodiments shown and described herein;

FIG. 4 depicts an exemplary multilayer composite comprising an adhesive seam film adhered to a release liner, according to one or more embodiments shown and described herein;

FIG. 5 depicts an exemplary adhesive webbing, according to one or more embodiments shown and described herein

FIG. 6 depicts an exemplary seam, according to one or more embodiments shown and described herein;

FIG. 7 depicts another exemplary seam, according to one or more embodiments shown and described herein; and

FIG. 8 depicts an exemplary seam with stiches, according to one or more embodiments shown and described herein.

### DETAILED DESCRIPTION

Reference will now be made in detail to various embodiments of adhesive seam films and seams formed therefrom.

The disclosure should not be construed as limited to the embodiments set forth herein. Rather, these embodiments are provided so that this disclosure will be thorough and complete, and will fully convey the subject matter to those skilled in the art.

### DEFINITIONS

Unless otherwise expressly defined, all technical and scientific terms used herein have the same meaning as commonly understood by a person of ordinary skill in the art. The terminology used in the disclosure herein is for describing particular embodiments only and is not intended to be limiting.

Unless otherwise expressly stated, it not intended that any method disclosed herein be construed as requiring that its steps be performed in a specific order, nor that any article set forth herein be construed as requiring specific orders or orientations to its individual components.

Unless otherwise expressly stated, it is intended that any composition or mixture disclosed herein may comprise, consist essentially of, or consist of the disclosed components.

As used herein, the singular form of a term is intended to include the plural form of the term, unless the context clearly indicates otherwise.

As used herein, numerical values are not strictly limited to the exact numerical value recited. Instead, unless otherwise expressly stated, each numerical value is intended to mean both the exact numerical value and “about” the numerical value, which encompasses a functionally equivalent range surrounding that numerical value, such that either possibility is contemplated as an embodiment disclosed herein.

As used herein, the terms “adhesion” or “bonding strength” refer to the ability of a material to adhere to another material, as determine by peel force.

As used herein, the term “peel force” refers to the force required to separate two layers of fabric from an adhesive seam film, which is situated between the two layers of fabric and bonded at 160 °C under 35 kPa for 15 seconds as measured by an Instron tensile tester. The two ends of the fabric layers are mounted on the Instron tensile tested and pulled apart at 2 inches per minute to separate the two layers of fabric from the adhesive seam film. Peel force is provided in Newtons per linear meter (i.e., N/m).

As used herein, the term “elasticity” refers to the stretchiness of a material, as determined by measuring the load at 200% using the two cycle 200% stretch test.

As used herein, the term “elastic recovery” refers to the ability of a material to return to its original shape when a load is removed, as determined by measuring hysteresis using the two cycle 200% stretch test.

As used herein, the term “two cycle 200% stretch test” refers to the following process. In a first cycle, a 1 inch long and 1 inch wide film is mounted in the jaws of an Instron tensile tester and pulled to 200% extension at a rate of 10 inches/minute. The film is then held at that extension for 2 minutes. After the 2 minutes, the Instron returns the film to its original length of 2 inches and holds the film in that position for one minute. In a second cycle, the film is again pulled to 200% extension at a rate of 10 inches/minute. The film is then held at that extension for 2 minutes and the load on the film is measured (i.e., load at 200%). After the 2 minutes, the Instron returns the film to its original length of 2 inches and holds the film in that position for one minute. After the second cycle, the hysteresis is measured by determining the length of the deformed film and calculating the percent difference between the original 2 inch length and the deformed length. For example, if, after two cycles, the film becomes 2.4 inches long due to permanent deformation, then it is considered to have 20% hysteresis.

As used herein, the term “surface tack” refers to the strength at which an adhesive seam film can stick to itself.

As used herein, the term “polydispersity” refers to a molecular weight distribution metric measured as the weight average molecular weight (MW) divided by the number average molecular weight (MN).

As used herein, the term “weight average molecular weight” refers to the weighted sum of all the molecular weights in the population, where the weighting factor is the mole fraction of each molecule sum of the weight of all chains in the polymer divided by the total number of chains, as measured according to Gel Permeation Chromatography (GPC) using polystyrene standards.

As used herein, the term “number average molecular weight” refers to the statistical average molecular weight of all polymer chains in the sample and is the sum of the weight of all chains in the polymer divided by the total number of chains, as measured according to Gel Permeation Chromatography (GPC) and Size Exclusion Chromatography (SEC) using polystyrene standards.

As used herein, the term “glass transition temperature” refers to the temperature at which an amorphous polymer changes from a hard/glassy state to a soft/leathery state, or vice versa.

As used herein, the term “softening temperature” refers to the temperature at which a polymer flows under a load on heating.

As used herein, the term “film” refers to a thin continuous material having a thickness less than or equal to 350 μm thick.

As used herein, the term “thin adhesive seam film” refers to a film having a thickness less than or equal to 250 μm.

As used herein, the term “melt flow rate” refers to a measure of ease of flow of a melted material through an orifice at a specified temperature and load, as measured according to ASTM D1238. The term “melt flow index” also may be used to refer to melt flow rate.

As used herein, the term “formed from” (including related terms such as “forming”) refers to, with respect to an article (or component of an article) and an adhesive film composition, that the article (or component of the article) is extruded, molded, shaped, pressed, or otherwise made, in whole or in part, from the adhesive film composition under sufficient heating to enable such forming. As such, the term “formed from” (including related terms such as “forming”) means, in some embodiments, the article (or component of an article) can comprise, consist essentially of, or consist of, the adhesive film composition; and, in other embodiments, the article (or component of an article) consists of the adhesive film composition because the article (or component of an article) is, for example, made by an extrusion process or a molding process.

### Usefulness

As discussed hereinabove, thermoplastic polyurethane compositions are commonly used in the apparel industry, such as in seamless elastic tapes, due to their desirable mechanical properties and durability. However, the use of thermoplastic polyurethane compositions may be cost prohibitive. Moreover, thermoplastic polyurethane compositions and other commonly used thermoplastic compositions may be in various forms, such as sprays or gels, that are difficult to work with and create unnecessary production delays.

Disclosed herein are adhesive film compositions. Specifically, the adhesive film compositions disclosed herein include a styrene-ethylene/butylene-styrene triblock copolymer, a white mineral oil, and optionally, a tackifier. Advantageously, the styrene-ethylene/butylene-styrene triblock copolymer, white mineral oil, and optionally tackifier, help to achieve an adhesive film composition that may be used to form a thin adhesive seam film. Moreover, the adhesive film compositions may exhibit desirable adhesion or bonding strength, elasticity, elastic recovery, and/or surface tack.

Accordingly, the adhesive film compositions may be used to form any article that requires a thin adhesive seam film or webbing. The adhesive film compositions are especially useful in seamless construction of performance apparel, intimate apparel, casual wear, and commodity undergarments.

The adhesive film compositions described herein the adhesive film compositions disclosed herein include a styrene-ethylene/butylene-styrene triblock copolymer, a white mineral oil, and optionally, a tackifier.

### Styrene-Ethylene/Butylene-Styrene Triblock Copolymer

The adhesive film compositions disclosed herein comprise a styrene-ethylene/butylene-styrene triblock copolymer. The styrene-ethylene/butylene-styrene triblock copolymer is included to impart adhesion, elasticity, and surface tack to the adhesive film compositions.

In embodiments, the adhesive film composition may comprise a minimum amount of the styrene-ethylene/butylene-styrene triblock copolymer (e.g., greater than or equal to 21 wt %) such that the adhesive film composition has a minimum melt flow rate (e.g., greater than or equal to 8 grams per 10 minute (g/10 min), as measured at 175 degrees Celsius (°C) under a 2.16 kilogram (kg), load) suitable for forming a film and such that adhesion, elasticity, and surface tack are imparted to the adhesive film composition. The amount of the styrene-ethylene/butylene-styrene triblock copolymer may be limited (e.g., less than or equal to 85 wt %) to achieve a desired elasticity and to maintain the melt flow rate below a certain threshold (e.g., less than or equal to 60 g/10 min, as measured at 175 °C under a 2.16 kg load) such that the adhesive film composition may be processed into a film. Accordingly, in embodiments, the adhesive film composition may comprise, based on a total weight of the adhesive film composition, 21 wt % to 85 wt % of the styrene-ethylene/butylene-styrene triblock copolymer. In embodiments, the amount of the styrene-ethylene/butylene-styrene triblock copolymer in the adhesive film composition may be, based on a total weight of the adhesive film composition, greater than or equal to 21 wt %, greater than or equal to 25 wt %, greater than or equal to 30 wt %, greater than or equal to 35 wt %, or even greater than or equal to 40 wt %. In embodiments, the amount of the styrene-ethylene/butylene-styrene triblock copolymer in the adhesive film composition may be, based on a total weight of the adhesive film composition, less than or equal to 85 wt %, less than or equal to 80 wt %, less than or equal to 65 wt %, less than or equal to 60 wt %, less than or equal to 55 wt %, less than or equal to 53 wt %, less than or equal to 50 wt %, or even less than or equal to 47 wt %. In embodiments, the amount of the styrene-ethylene/butylene triblock copolymer in the adhesive film composition may be, based on a total weight of the adhesive film composition, from 21 wt % to 85 wt %, from 21 wt % to 80 wt %, from 21 wt % to 65 wt %, from 21 wt % to 60 wt %, from 21 wt % to 55 wt %, from 21 wt % to 53 wt %, from 21 wt % to 50 wt %, from 21 wt % to 47 wt %, from 25 wt % to 85 wt %, from 25 wt % to 80 wt %, from 25 wt % to 65 wt %, from 25 wt % to 60 wt %, from 25 wt % to 55 wt %, from 25 wt % to 53 wt %, from 25 wt % to 50 wt %, from 25 wt % to 47 wt %, from 30 wt % to 85 wt %, from 30 wt % to 80 wt %, from 30 wt % to 65 wt %, from 30 wt % to 60 wt %, from 30 wt % to 55 wt %, from 30 wt % to 53 wt %, from 30 wt % to 50 wt %, from 30 wt % to 47 wt %, from 35 wt % to 85 wt %, from 35 wt % to 80 wt %, from 35 wt % to 65 wt %, from 35 wt % to 60 wt %, from 35 wt % to 55 wt %, from 35 wt % to 53 wt %, from 35 wt % to 50 wt %, from 35 wt % to 47 wt %, from 40 wt % to 85 wt %, from 40 wt % to 80 wt %, from 40 wt % to 65 wt %, from 40 wt % to 60 wt %, from 40 wt % to 55 wt %, from 40 wt % to 53 wt %, from 40 wt % to 50 wt %, or even from 40 wt % to 47 wt %, or any and all sub-ranges formed from any of these endpoints.

The amount of styrene-ethylene/butylene-styrene triblock copolymer included in the adhesive film composition may depend on the weight average molecular weight of the styrene-ethylene/butylene-styrene triblock copolymer. As the weight average molecular weight of the styrene-ethylene/butylene-styrene triblock copolymer increases, the amount of styrene-ethylene/butylene-styrene triblock copolymer in the adhesive film composition may be adjusted accordingly. For example, if a styrene-ethylene/butylene-styrene triblock copolymer with a weight average molecular weight of 140,000 g/mol is used, then a relatively lower weight percentage, such as about 21 wt % of the styrene-ethylene/butylene-styrene triblock copolymer based on the total weight of the adhesive film composition, may be included to achieve the desired properties.

As another example, if a styrene-ethylene/butylene-styrene triblock copolymer with a weight average molecular weight of 90,000 g/mol is used, then a relatively higher weight percentage, such as near 55% of a styrene-ethylene/butylene-styrene triblock copolymer, based on the total weight of the adhesive film composition, may be included to achieve the desired properties.

In embodiments, the styrene-ethylene/butylene-styrene triblock copolymer may have a minimum molecular weight (e.g., greater than or equal to 90,000 grams per mole (g/mol)) such that the adhesive film composition to impart elastic recovery to the adhesive film composition. The molecular weight of the styrene-ethylene/butylene-styrene triblock copolymer may be limited (e.g., less than or equal to 140,000 g/mol) to allow the adhesive film composition to be made into a film or webbing. Accordingly, in embodiments, the styrene-ethylene/butylene-styrene triblock copolymer may have a weight average molecular weight of 90,000 g/mol to 140,000 g/mol.

In embodiments, the styrene-ethylene/butylene-styrene triblock copolymer may have a minimum bound styrene content (e.g., greater than or equal to 28 wt %) such the styrene-ethylene-butylene-styrene separates into distinct rubbery and plastic phases in the adhesive film composition. The weight percent of bound styrene content may be limited (e.g., less than or equal to 35 wt %) so that there is a balance of elastic phase and plastic phase in the adhesive film composition in order to develop elastic recovery. Accordingly, in embodiments, the styrene-ethylene/butylene-styrene triblock copolymer may have a bound styrene content of 28 wt % to 35 wt %, based on the total weight of the styrene-ethylene/butylene-styrene triblock copolymer. In embodiments, the bound styrene content of the styrene-ethylene/butylene-styrene triblock copolymer may, based on the total weight of the styrene-ethylene/butylene-styrene triblock copolymer, greater than or equal to 28 wt %, greater than or equal to 28.5 wt %, or even greater than or equal to 29 wt %. In embodiments, the bound styrene content of the styrene-ethylene/butylene-styrene triblock copolymer may be, based on the total weight of the styrene-ethylene/butylene-styrene triblock copolymer, less than or equal to 35 wt %, less than or equal to 33 wt %, or even less than or equal to 30 wt %. In embodiments, the bound styrene content of the styrene-ethylene/butylene triblock copolymer may be, based on a total weight of the styrene-ethylene/butylene-styrene triblock copolymer, from 28 wt % to 35 wt %, from 28 wt % to 33 wt %, from 28 wt % to 30 wt %, from 28.5 wt % to 35 wt %, from 28.5 wt % to 33 wt %, from 28.5 wt % to 30 wt %, from 29 wt % to 35 wt %, from 29 wt % to 33 wt %, or even from 29 wt % to 30 wt % or any and all sub-ranges formed from any of these endpoints.

In embodiments, the styrene-ethylene/butylene-styrene triblock copolymer may have a polydispersity from 1.0 to 3.0 such that the adhesive film composition is able to flow so that it may be made into a film or webbing. In embodiments, the polydispersity of the styrene-ethylene/butylene-styrene triblock copolymer may be greater than or equal to 1.0, greater than or equal to 1.1, or even greater than or equal to 1.2. In embodiments, the polydispersity of the styrene-ethylene/butylene-styrene triblock copolymer may be less than or equal to 1.3, less than or equal to 1.2, or even less than or equal to 1.1. In embodiments, the polydispersity of the styrene-ethylene/butylene-styrene triblock copolymer may be from 1.0 to 1.3, from 1.0 to 1.2, from 1.0 to 1.1, from 1.1 to 1.3, from 1.1 to 1.2, or even from 1.2 to 1.3, or any and all sub-ranges formed from any of these endpoints.

Suitable styrene-ethylene/butylene-styrene triblock copolymers are available under the KRATON brand from Kraton, such as grade G1650.

In embodiments, the adhesive film compositions may include a maleic anhydride grafted styrene-ethylene/butylene-styrene triblock copolymer. A maleic anhydride grafted styrene-ethylene/butylene-styrene triblock copolymer includes a maleic anhydride residue grafted on to a styrene-ethylene/butylene-styrene triblock copolymer, the maleic anhydride residue may be grafted, for example, on the ethylene/butylene block. Suitable maleic anhydride grafted styrene-ethylene/butylene-styrene triblock copolymers are available under the KRATON brand from Kraton, such as grade FG1901 G.

In embodiments, the maleic anhydride grafted styrene-ethylene/butylene-styrene triblock copolymer may have a minimum molecular weight (e.g., greater than or equal to 5,000 grams per mole (g/mol)). The molecular weight of the maleic anhydride grafted styrene-ethylene/butylene-styrene triblock copolymer may be limited (e.g., less than or equal to 200,000 g/mol). Accordingly, in embodiments, the styrene-ethylene/butylene-styrene triblock copolymer may have a weight average molecular weight of 5,000 g/mol to 200,000 g/mol, 7,000 g/mol to 150,000 g/mol, 9,000 g/mol to 140,000 g/mol, 10,000 g/mol to 120,000 g/mol, 20,000 g/mol to 80,000 g/mol, or any and all sub-ranges formed from any of these endpoints.

In embodiments, the maleic anhydride grafted styrene-ethylene/butylene-styrene triblock copolymer may have a minimum bound styrene content (e.g., greater than or equal to 28 wt %). In embodiments, the maleic anhydride grafted styrene-ethylene/butylene-styrene triblock copolymer may have a maximum bound styrene content (e.g., less than or equal to 35 wt %). Accordingly, in embodiments, the maleic anhydride grafted styrene-ethylene/butylene-styrene triblock copolymer may have a bound styrene content of 28 wt % to 35 wt %, based on the total weight of the maleic anhydride grafted styrene-ethylene/butylene-styrene triblock copolymer. In embodiments, the bound styrene content of the maleic anhydride grafted styrene-ethylene/butylene-styrene triblock copolymer may, based on the total weight of the maleic anhydride grafted styrene-ethylene/butylene-styrene triblock copolymer, greater than or equal to 28 wt %, greater than or equal to 28.5 wt %, or even greater than or equal to 29 wt %. In embodiments, the bound styrene content of the maleic anhydride grafted styrene-ethylene/butylene-styrene triblock copolymer may be, based on the total weight of the maleic anhydride grafted styrene-ethylene/butylene-styrene triblock copolymer, less than or equal to 35 wt %, less than or equal to 33 wt %, or even less than or equal to 30 wt %. In embodiments, the bound styrene content of the maleic anhydride grafted styrene-ethylene/butylene triblock copolymer may be, based on a total weight of the maleic anhydride grafted styrene-ethylene/butylene-styrene triblock copolymer, from 28 wt % to 35 wt %, from 28 wt % to 33 wt %, from 28 wt % to 30 wt %, from 28.5 wt % to 35 wt %, from 28.5 wt % to 33 wt %, from 28.5 wt % to 30 wt %, from 29 wt % to 35 wt %, from 29 wt % to 33 wt %, or even from 29 wt % to 30 wt % or any and all sub-ranges formed from any of these endpoints.

In embodiments, the maleic anhydride grafted styrene-ethylene/butylene-styrene triblock copolymer may have a minimum maleic anhydride content (e.g., greater than or equal to 0.9 wt %). In embodiments, the maleic anhydride grafted styrene-ethylene/butylene-styrene triblock copolymer may have a maximum anhydride content (e.g., less than or equal to 2 wt %). Accordingly, in embodiments, the maleic anhydride grafted styrene-ethylene/butylene-styrene triblock copolymer may have a anhydride content of 0.9 wt % to 2 wt %, based on the total weight of the maleic anhydride grafted styrene-ethylene/butylene-styrene triblock copolymer. In embodiments, the maleic anhydride content of the maleic anhydride grafted styrene-ethylene/butylene-styrene triblock copolymer may, based on the total weight of the maleic anhydride grafted styrene-ethylene/butylene-styrene triblock copolymer, greater than or equal to 0.9 wt %, greater than or equal to 1 wt %, or even greater than or equal to 1.3 wt %. In embodiments, the maleic anhydride content of the maleic anhydride grafted styrene-ethylene/butylene-styrene triblock copolymer may be, based on the total weight of the maleic anhydride grafted styrene-ethylene/butylene-styrene triblock copolymer, less than or equal to 2 wt %, less than or equal to 1.9 wt %, or even less than or equal to 1.8 wt %. In embodiments, the maleic anhydride content of the maleic anhydride grafted styrene-ethylene/butylene triblock copolymer may be, based on a total weight of the maleic anhydride grafted styrene-ethylene/butylene-styrene triblock copolymer, from 0.9 wt % to 2 wt %, from 0.9 wt % to 1.9 wt %, from 0.9 wt % to 1.8 wt %, from 1 wt % to 2 wt %, from 1 wt % to 1.9 wt %, from 1 wt % to 1.8 wt %, from 1.3 wt % to 2 wt %, from 1.3 wt % to 1.9 wt %, or even from 1.3 wt % to 1.8 wt % or any and all sub-ranges formed from any of these endpoints.

In embodiments, the ratio of the styrene-ethylene/butylene-styrene triblock copolymer to the maleic anhydride grafted styrene-ethylene/butylene-styrene triblock copolymer may be up to 1:1. In embodiments, the ratio of the styrene-ethylene/butylene-styrene triblock copolymer to the maleic anhydride grafted styrene-ethylene/butylene-styrene triblock copolymer may be from 1:1 to 100:1, 1:0.9 to 90:1, 1:0.8 to 80:1, 1:0.7 to 70:1, 1:0.6 to 60:1, or any and all sub-ranges formed from any of these endpoints.

In embodiments, the adhesive film composition may comprise a minimum amount of the maleic anhydride grafted styrene-ethylene/butylene-styrene triblock copolymer (e.g., greater than or equal to 0.5 wt %). The amount of the maleic anhydride grafted styrene-ethylene/butylene-styrene triblock copolymer may be limited (e.g., less than or equal to 42.5 wt %). Accordingly, in embodiments, the adhesive film composition may comprise, based on a total weight of the adhesive film composition, 0.5 wt % to 42.5 wt % of the maleic anhydride grafted styrene-ethylene/butylene-styrene triblock copolymer. In embodiments, the amount of the maleic anhydride grafted styrene-ethylene/butylene-styrene triblock copolymer in the adhesive film composition may be, based on a total weight of the adhesive film composition, greater than or equal to 0.5 wt %, greater than or equal to 1 wt %, greater than or equal to 3 wt %, greater than or equal to 5 wt %, or even greater than or equal to 10 wt %. In embodiments, the amount of the styrene-ethylene/butylene-styrene triblock copolymer in the adhesive film composition may be, based on a total weight of the adhesive film composition, less than or equal to 42.5 wt %, less than or equal to 40 wt %, less than or equal to 32 wt %, less than or equal to 25 wt %, less than or equal to 22 wt %, less than or equal to 20 wt %, less than or equal to 17 wt %, or even less than or equal to 15 wt %. In embodiments, the amount of the styrene-ethylene/butylene triblock copolymer in the adhesive film composition may be, based on a total weight of the adhesive film composition, from 0.5 wt % to 42.5 wt %, from 0.5 wt % to 40 wt %, from 0.5 wt % to 32 wt %, from 0.5 wt % to 22 wt %, from 0.5 wt % to 20 wt %, from 0.5 wt % to 17 wt %, from 0.5 wt % to 15 wt %, from 1 wt % to 42.5 wt %, from 1 wt % to 40 wt %, from 1 wt % to 32 wt %, from 1 wt % to 22 wt %, from 1 wt % to 20 wt %, from 1 wt % to 17 wt %, from 1 wt % to 15 wt %, from 3 wt % to 42.5 wt %, from 3 wt % to 40 wt %, from 3 wt % to 32 wt %, from 3 wt % to 22 wt %, from 3 wt % to 20 wt %, from 3 wt % to 17 wt %, from 3 wt % to 15 wt %, from 5 wt % to 42.5 wt %, from 5 wt % to 40 wt %, from 5 wt % to 32 wt %, from 5 wt % to 22 wt %, from 5 wt % to 20 wt %, from 5 wt % to 17 wt %, from 5 wt % to 15 wt %, from 10 wt % to 42.5 wt %, from 10 wt % to 40 wt %, from 10 wt % to 32 wt %, from 10 wt % to 22 wt %, from 10 wt % to 20 wt %, from 10 wt % to 17 wt %, from 10 wt % to 15 wt %, or any and all sub-ranges formed from any of these endpoints.

### White Mineral Oil

The adhesive film compositions disclosed herein comprise a white mineral oil. The white mineral oil is included in the adhesive film composition to impart processability to the adhesive film composition to, for example, allow the adhesive film composition to be extruded so that it can be made into a film. The white mineral oil may also balance the viscosity and melt flow rate of the adhesive film composition at processing temperatures to allow the allow the adhesive film composition to be extruded so that it can be made into a film.

In embodiments, the adhesive film composition may comprise a minimum amount of the white mineral oil (e.g., greater than or equal to 27 wt %) to ensure that the adhesive film composition has a limited melt flow rate (e.g., less than or equal to 60 g/10 min, as measured at 175 °C under a 2.16 kg load) so that the adhesive film composition may be able to spread and flow during processing to form an adhesive seam film with a thickness of less than or equal to 250 μm. The amount of the white mineral oil may be limited (e.g., less than or equal to 35.5 wt %) to maintain the melt flow rate above a certain threshold (e.g., greater than or equal to 8 g/10 min, as measured at 175 °C under a 2.16 kg load) such that the adhesive film composition may not fall apart when it is processed into an adhesive seam film. Accordingly, in embodiments, the adhesive film composition may comprise, based on a total weight of the adhesive film composition, 15 wt % to 35.5 wt % of the white mineral oil. In embodiments, the amount of the white mineral oil may be, based on a total weight of the adhesive film composition, greater than or equal to 15 wt %, greater than or equal to 20 wt %, greater than or equal to 22 wt %, greater than or equal to 25 wt %, greater than or equal to 27 wt %, greater than or equal to 30 wt %, or even greater than or equal to 33 wt %. In embodiments, the amount of the white mineral oil in the adhesive film composition may be, based on a total weight of the adhesive film composition, less than or equal to 35.5 wt %, less than or equal to 35 wt %, or even less than or equal to 34.5 wt %. In embodiments, the amount of the white mineral oil in the adhesive film composition may be, based on a total weight of the adhesive film composition, from 15 wt % to 35.5 wt %, from 15 wt % to 35 wt %, from 15 wt % to 34.5 wt %, from 20 wt % to 35.5 wt %, from 20 wt % to 35 wt %, from 20 wt % to 34.5 wt %, from 22 wt % to 35.5 wt %, from 22 wt % to 35 wt %, from 22 wt % to 34.5 wt %, from 25 wt % to 35.5 wt %, from 25 wt % to 35 wt %, from 25 wt % to 34.5 wt %, from 27 wt % to 35.5 wt %, from 27 wt % to 35 wt %, from 27 wt % to 34.5 wt %, from 30 wt % to 35.5 wt %, from 30 wt % to 35 wt %, from 30 wt % to 34.5 wt %, from 33 wt % to 35.5 wt %, from 33 wt % to 35 wt %, or even from 33 wt % to 34.5 wt %, or any and all sub-ranges formed from any of these endpoints.

Suitable white mineral oils are commercially available under the HYDROBRITE brand from Sonneborn, such as grades 380, 100, and 550.

### Tackifier

The adhesive film compositions disclosed herein optionally comprise a tackifier. The tackifier may be included in the adhesive film composition to impart adhesion and surface tack.

The adhesive film composition may comprise a minimum amount of tackifier (i.e., greater than 0 wt %) to impart adhesion to the adhesive film composition. The amount of the tackifier may be limited (e.g., less than or equal to 40 wt %) to ensure that the surface tack is below a certain threshold to allow for processing in equipment and handling. Accordingly, in embodiments, the adhesive film composition may comprise, based on a total weight of the adhesive film composition, 0 wt % to 40 wt % of the tackifier. In embodiments, the amount of the tackifier may be, based on a total weight of the adhesive film composition, greater than or equal to 0 wt %, greater than or equal to 5 wt %, greater than or equal to 10 wt %, greater than or equal to 15 wt %, or even greater than or equal to 19 wt %. In embodiments, the amount of the tackifier in the adhesive film composition may be, based on a total weight of the adhesive film composition, less than or equal to 40 wt %, less than or equal to 35 wt %, less than or equal to 30 wt %, less than or equal to 27 wt %, less than or equal to 25 wt %, or even less than or equal to 23 wt %. In embodiments, the amount of the tackifier in the adhesive film composition may be, based on a total weight of the adhesive film composition, for 0 wt % to 40 wt %, from 0 wt % to 35 wt %, from 0 wt % to 30 wt %, from 0 wt % to 27 wt %, from 0 wt % to 25 wt %, from 0 wt % to 23 wt %, from 5 wt % to 40 wt %, from 5 wt % to 35 wt %, from 5 wt % to 30 wt %, from 5 wt % to 27 wt %, from 5 wt % to 25 wt %, from 5 wt % to 23 wt %, from 10 wt % to 40 wt %, from 10 wt % to 35 wt %, from 10 wt % to 30 wt %, from 10 wt % to 27 wt %, from 10 wt % to 25 wt %, from 10 wt % to 23 wt %, from 15 wt % to 40 wt %, from 15 wt % to 35 wt %, from 15 wt % to 30 wt %, from 15 wt % to 27 wt %, from 15 wt % to 25 wt %, from 15 wt % to 23 wt %, from 19 wt % to 40 wt %, from 19 wt % to 35 wt %, from 19 wt % to 30 wt %, from 19 wt % to 27 wt %, from 19 wt % to 25 wt %, or even from 19 wt % to 23 wt %, or any and all sub-ranges formed from any of these endpoints.

In embodiments, the tackifier may comprise a minimum molecular weight (e.g., greater than or equal to 500 g/mol) to maintain viscosity below a certain threshold such that it may be made into a film. The molecular weight of the tackifier may be limited (e.g., less than or equal to 5000 g/mol) so that the tackifier is able to disperse in the adhesive film composition and associate with the other compounds in the adhesive film composition. Accordingly, in embodiments, the tackifier may comprise molecular weight of 500 g/mol to 5000 g/mol. In embodiments, the tackifier in the adhesive film composition may comprise a molecular weight of greater than or equal to 500 g/mol, greater than or equal to 1000 g/mol, or even greater than or equal to 2000 g/mol. In embodiments, the amount of the tackifier in the adhesive film composition may comprise a molecular weight of less than or equal to 5000 g/mol, less than or equal to 4000 g/mol, or even less than or equal to 3000 g/mol. In embodiments, the tackifier in the adhesive film composition may comprise a molecular weight from 500 g/mol to 5000 g/mol, from 500 g/mol to 4000 g/mol, from 500 g/mol to 3000 g/mol, from 1000 g/mol to 5000 g/mol, from 1000 g/mol to 4000 g/mol, from 1000 g/mol to 3000 g/mol, from 2000 g/mol to 5000 g/mol, from 2000 g/mol to 4000 g/mol, or even from 2000 g/mol to 3000 g/mol, or any and all sub-ranges formed from any of these endpoints.

In embodiments, the tackifier may comprise a minimum glass transition temperature (e.g., greater than or equal to 50 °C) such that the adhesive film composition does not soften at the temperature of the environment or at the body temperature of the wearer. The glass transition temperature of the tackifier may be limited (e.g., less than or equal to 100 °C) so that the adhesive film composition is able to flow at the temperature at which an adhesive seam film comprising the adhesive film composition is bonded to a fabric. Accordingly, in embodiments, the tackifier may comprise a glass transition temperature from 50 °C to 100 °C. In embodiments, the tackifier in the adhesive film composition may comprise a glass transition temperature greater than or equal to 50 °C, greater than or equal to 60 °C, or even greater than or equal to 75 °C. In embodiments, the tackifier may comprise a glass transition temperature less than or equal to 100 °C, less than or equal to 90 °C, or even less than or equal to 80 °C. In embodiments, the tackifier in the adhesive film composition may comprise a glass transition temperature from 50 °C to 100 °C, from 50 °C to 90 °C, from 50 °C to 80 °C, from 60 °C to 100 °C, from 60 °C to 90 °C, from 60 °C to 80 °C, from 75 °C to 100 °C, from 75 °C to 90 °C, or even from 75 °C to 80 °C, or any and all sub-ranges formed from any of these endpoints.

In embodiments, the tackifier may comprise a minimum softening temperature (e.g., greater than or equal to 100 °C) so that the adhesive film composition is able to flow at the temperature at which an adhesive seam film comprising the adhesive film composition is bonded to a fabric. The softening temperature of the tackifier may be limited (e.g., less than or equal to 140 °C) so that an adhesive seam film comprising the adhesive film composition melts and flows at the temperature at which the film is bonded to a fabric. Accordingly, in embodiments, the tackifier may comprise a softening temperature from 100 °C to 140 °C. In embodiments, the tackifier in the adhesive film composition may comprise a softening temperature greater than or equal to 100 °C, greater than or equal to 110 °C, or even greater than or equal to 120 °C. In embodiments, the tackifier may comprise a softening temperature less than or equal to 140 °C, less than or equal to 135 °C, or even less than or equal to 125 °C. In embodiments, the tackifier in the adhesive film composition may comprise a softening temperature from 100 °C to 140 °C, from 100 °C to 135 °C, from 100 °C to 125 °C, from 110 °C to 140 °C, from 110 °C to 135 °C, from 110 °C to 125 °C, from 120 °C to 140 °C, from 120 °C to 135 °C, or even from 120 °C to 135 °C, or any and all sub-ranges formed from any of these endpoints.

The glass transition temperature and the softening temperature of the tackifier may vary based on the weight average molecular weight of the tackifier. Thus, the weight average molecular weight of the tackifier may be selected based on the desired glass transition temperature and softening temperature. As the weight average molecular weight increases, the glass transition temperature and the softening temperature will also increase. The softening temperature is the temperature at which the tackifier will bond with fabric to form a seam. For example, if bonding of the adhesive film composition to fabric is desired at a temperature of 100 °C, then a tackifier with a weight average molecular weight near 500 g/mol may be selected. As another example, if bonding of the adhesive film composition to fabric is desired at a temperature of 140 °C, then a tackifier with a weight average molecular weight near 5000 g/mol may be selected.

Suitable tackifiers are commercially available under the brand name PLASTOLYN from Synthomer, such as grade 290, under the brand name KRISTALEX from Synthomer, such as grade 5140; and under the brand name ESCOREZ from Exxon Mobile, such as grade 5300.

In embodiments, the tackifier may be a mid-block associating tackifier that has affinity to the midblock (e.g., the ethylene/butylene block) of the styrene-ethylene/butylene-styrene triblock copolymer. Useful mid-block associating tackifiers include, for example, natural and modified rosins, glycerol and pentaerythritol esters of natural and modified rosins, copolymers and terpolymers of natural terpenes, polyterpene resins, phenolic modified terpene resins and hydrogenated derivatives thereof, aliphatic petroleum hydrocarbon resins, alicyclic petroleum hydrocarbon resins and the hydrogenated derivatives thereof, aromatic/aliphatic or alicyclic hydrocarbon resins. Suitable mid-block associating tackifiers may be sold under the brand name ESCOREZ from Exxon Mobile, such as grade 5300.

### Other Additives

In embodiments, adhesive film compositions as disclosed herein may further comprise one or more optional other additives.

Suitable other additives may include conventional or commercially available plastics additives. Those skilled in the art of thermoplastics compounding, without undue experimentation, may select suitable additives from available references, for example, E. W. Flick, “Plastics Additives Database,” Plastics Design Library (Elsevier 2004).

Optional other additives may be used in any amount that is sufficient to obtain a desired processing or performance property for the material or component formed therefrom. The amount should not be wasteful of the additive nor detrimental to the processing or performance of the material or article formed therefrom.

Non-limiting examples of optional other additives may include one or more of antioxidants; nucleating agents; colorants (e.g., pigments and/or dyes); inorganic mineral fillers; mineral oils, flame retardants; glass beads, glass flakes, and glass fibers; impact modifiers; micas; slip and anti-blocking agents; ultraviolet light absorbers; and waxes.

### Method of Preparing Adhesive Film Composition

In embodiments, a method of preparing an adhesive film composition may comprise combining a styrene-ethylene/butylene-styrene triblock copolymer, a white mineral oil, and optionally a tackifier, as disclosed herein, for example, a single screw extruder or a twin screw extruder.

The extruder may be operated at a temperature from 125 °C to 450 °C, from 125 °C to 400 °C, from 125 °C to 375 °C, from 180 °C to 450 °C, from 180 °C to 400 °C, from 180 °C to 375 °C, from 200 °C to 450 °C, from 200 °C to 400 °C, or even from 200 °C to 375 °C, or any and all sub-ranges formed from any of these endpoints.

The extruder may be operated at a shear rate from 100 s⁻¹ to 10000 s⁻¹, from 100 s⁻¹ to 5000 s⁻¹, from 100 s⁻¹ to 2500 s⁻¹, from 500 s⁻¹ to 10000 s⁻¹, from 500 s⁻¹ to 5000 s⁻¹, from 500 s⁻¹ to 2500 s⁻¹, from 1000 s⁻¹ to 10000 s⁻¹, from 1000 s⁻¹ to 5000 s⁻¹, or even from 1000 s⁻¹ to 2500 s⁻¹, or any and all sub-ranges formed from any of these endpoints.

Operating the extruder at the temperatures and shear rates disclosed herein may ensure the flow and homogenous mixing of the styrene-ethylene/butylene-styrene triblock copolymer, white mineral oil, and optionally, tackifier. In some embodiments, the adhesive film composition may be pelletized after it is extruded.

### Adhesive Film Composition

As described herein, the styrene-ethylene/butylene-styrene triblock copolymer, white mineral oil, and optionally tackifier help to achieve an adhesive film composition that may be used to form the a thin adhesive seam film. Moreover, the adhesive film compositions may exhibit desirable adhesion or bonding strength, elasticity, elastic recovery, and/or surface tack.

The ability to make a thin adhesive seam film from an adhesive film composition is dependent on the various properties of the adhesive film composition and the quantities and properties of the individual components in the adhesive film composition. Relevant properties of the adhesive film composition may include elasticity, elastic recovery, melt flow rate, adhesion, and viscosity. Relevant properties of the individual properties may include the molecular weight of the components.

Advantageously the selection and the amounts of the individual components of the adhesive film composition may be extruded into a thin adhesive seam film. The properties of the adhesive film composition harmonize to be able to be processed into a thin adhesive seam. Accordingly, changes to one or more properties may be offset by making responsive changes to one or more other properties. However, in some instances, if one or more properties is too far out of balance, changes to one or more other properties may not be sufficient to form a thin adhesive seam film. Thus, balancing of the quantities and properties of the individual components of the adhesive film composition may be important to achieving a thin adhesive seam film.

In embodiments, the adhesive film composition may have a peel force greater than or equal to 700 newton per linear meter (N/m) or even 750 N/m to ensure sufficient bonding to various materials, such as nylon and polyester.

In embodiments, the adhesive film composition may have a load at 200% from 200 kPa to 600 kPa, from 200 kPa to 400 kPa, from 300 kPa to 600 kPa, or even from 300 kPa to 400 kPa to ensure that the adhesive film composition has sufficient elasticity such that the apparel including the adhesive film composition is comfortable while remaining in place and on the body of the wearer.

In embodiments, the adhesive film composition may have a percent hysteresis less than or equal to 20%, less than or equal to 15%, less than or equal to 10%, less than or equal to 5%, less than or equal to 3%, less than or equal to 2%, less than or equal to 1%, less than or equal to 0.5%, or even less than or equal to 0.1% to ensure that the adhesive film composition has sufficient elastic recovery. In embodiments, the adhesive film composition may have a percent hysteresis of 0%.

In embodiments, the adhesive film composition may have a melt index from 8 g/10 min to 60 g/10 min, as measured according to ASTM D1238 at 175 °C and under 2.16 kg load, to ensure the adhesive film composition has sufficient flow for processing, particularly to form a film. In embodiments, the adhesive film composition may have a melt index of greater than or equal to 8 g/10 min, greater than or equal to 12 g/min, or even greater than or equal to 16 g/min, as measured according to ASTM D1238 at 175 °C and under 2.16 kg load. In embodiments, the adhesive film composition may have a melt index of less than or equal to 60 g/10 min, less than or equal to 40 g/min, or even less than or equal to 25 g/min, as measured according to ASTM D1238 at 175 °C and under 2.16 kg load. In embodiments, the adhesive film composition may have a melt index, as measured according to ASTM D1238 at 175 °C and under 2.16 kg load of from 8 g/10 min to 60 g/10 min, from 8 g/10 min to 40 g/10 min, from 8 g/10 min to 25 g/10 min, from 12 g/10 min to 60 g/10 min, from 12 g/10 min to 40 g/10 min, from 12 g/10 min to 25 g/10 min, from 16 g/10 min to 60 g/10 min, from 16 g/10 min to 40 g/10 min, or even from 16 g/10 min to 25 g/10 min, or any and all sub-ranges formed from any of these endpoints.

In embodiments, the adhesive film composition may have a melt index from 15 g/10 min to 35 g/10 min, as measured according to ASTM D1238 at 190 °C and under 2.16 kg load. In embodiments, the adhesive film composition may have a melt index of greater than or equal to 8 g/10 min, greater than or equal to 10 g/min, or even greater than or equal to 15 g/min, as measured according to ASTM D1238 at 190 °C and under 2.16 kg load. In embodiments, the adhesive film composition may have a melt index of less than or equal to 60 g/10 min, less than or equal to 40 g/min, or even less than or equal to 20 g/min, as measured according to ASTM D1238 at 190 °C and under 2.16 kg load. In embodiments, the adhesive film composition may have a melt index, as measured according to ASTM D1238 at 190 °C and under 2.16 kg load of from 8 g/10 min to 60 g/10 min, from 8 g/10 min to 40 g/10 min, from 8 g/10 min to 20 g/10 min, from 10 g/10 min to 60 g/10 min, from 10 g/10 min to 40 g/10 min, from 10 g/10 min to 20 g/10 min, from 15 g/10 min to 60 g/10 min, from 15 g/10 min to 40 g/10 min, or even from 15 g/10 min to 25 g/10 min, or any and all sub-ranges formed from any of these endpoints.

In embodiments, the adhesive film composition may have a surface tack such that the adhesive film composition may be manually handled with ease.

As described herein, the adhesive film compositions may be used to form any article that requires a thin adhesive seam film. The adhesive film compositions are especially useful in seamless construction of performance apparel, intimate apparel, casual wear, and commodity undergarments.

### Method of Forming Adhesive Seam Film

A method of forming an adhesive seam film may comprise preparing an adhesive film composition and extruding the adhesive film composition to form a film that has a thickness of 25 μm to 250 μm. The adhesive seam film may comprise an adhesive film composition according to one or more of the embodiments described herein.

For example, the prepared adhesive film composition or components thereof may be fed into an extruder and melt-mixed at a temperature greater than or equal to the melting temperature of the adhesive film composition. In embodiments, the adhesive film composition may be melt be melt-mixed at a temperature from 150 °C and 240 °C and for a time from 10 seconds (sec) to 120 sec. In embodiments, the adhesive film composition may be melt be melt-mixed at a temperature from 150 °C to 240 °C, from 150 °C to 230 °C, from 150 °C to 220 °C, from 160 °C to 240 °C, from 160 °C to 230 °C, from 160 °C to 220 °C, from 170 °C to 240 °C, from 170 °C to 230 °C, or even from 170 °C to 220 °C, or any and all sub-ranges formed from any of these endpoints. In embodiments, the adhesive film composition may be melt be melt-mixed for a time from 10 sec to 120 sec, from 10 sec to 90 sec, 10 sec to 60 sec, from 20 sec to 120 sec, from 20 sec to 90 sec, 20 sec to 60 sec, 30 sec to 120 sec, from 30 sec to 90 sec, or even from 30 sec to 60 sec, or any and all sub-ranges formed from any of these endpoints.

The adhesive film composition may be extruded from the extruder to form the film.

### Adhesive Seam Film

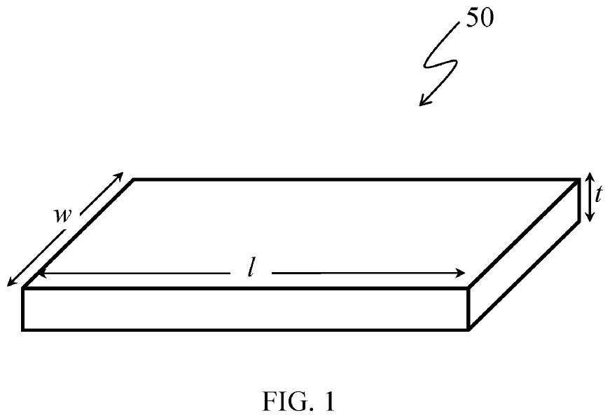

Referring now to FIG. 1, an adhesive seam film is shown at 50. The adhesive seam film 50 comprises a length l, a width w, and a thickness t. The adhesive seam film may comprise the adhesive film composition according to one or more of the embodiments described herein.

As described herein, the adhesive film compositions may be used to form thin adhesive seam films. In embodiments, the adhesive seam film 50 may have an appropriate thickness to provide minimal bulk in seamless construction and/or to achieve enhanced performance. For example, in embodiments, the adhesive seam film 50 may have a thickness t of 25 μm to 250 μm. In some embodiments, the adhesive seam film 50 may have a thickness t greater than or equal to 25 μm, greater than or equal to 50 μm, or even greater than or equal to 100 μm. In embodiments, the adhesive seam film 50 may have a thickness t less than or equal to 250 μm, less than or equal to 200 μm, or even less than or equal to 150 μm. In embodiments, the adhesive seam film 50 may have a thickness t from 25 μm to 250 μm, from 25 m to 200 μm, from 25 μm to 150 μm, from 50 μm to 250 μm, from 50 μm to 200 μm, from 50 μm to 150 μm, from 100 μm to 250 μm, from 100 μm to 200 m, or even from 100 μm to 150 μm, or any and all sub-ranges formed from any of these endpoints. The thickness of the adhesive seam film 50 may be determined by measuring the adhesive seam film 50 thickness t with a thickness gauge.

In embodiments, the width w may be selected to conform to the width of the manufacturing equipment used to conform to the width of a fabric to which the adhesive seam film is to be applied, especially if the adhesive seam film is extruded directly onto the fabric. In embodiments, the width w may be further reduced after manufacturing by cutting or slitting the film, especially if the film is extruded on to a release liner. For example, in embodiments, the adhesive seam film 50 may have a width w from 5 cm to 40 cm. In embodiments, the adhesive seam film 50 may have a width w greater than or equal to 5 cm, greater than or equal to 10 cm, or even greater than or equal to 20 cm. In embodiments, the adhesive seam film may have a width w less than or equal to 40 cm or even less than or equal to 30 cm. In embodiments, the adhesive seam film may have a width w from 5 cm to 40 cm, from 5 cm to 30 cm, from 10 cm to 40 cm, from 10 cm to 30 cm, from 20 cm to 40 cm, from 20 cm to 30 cm, or any and all sub-ranges formed from any of these endpoints.

In embodiments the adhesive seam film 50 may be coated with a polymeric powder or dusting agent to ensure ease of manual handling. Examples of a suitable polymeric powders and dusting agents may include powdered polyethylene and powdered polypropylene.

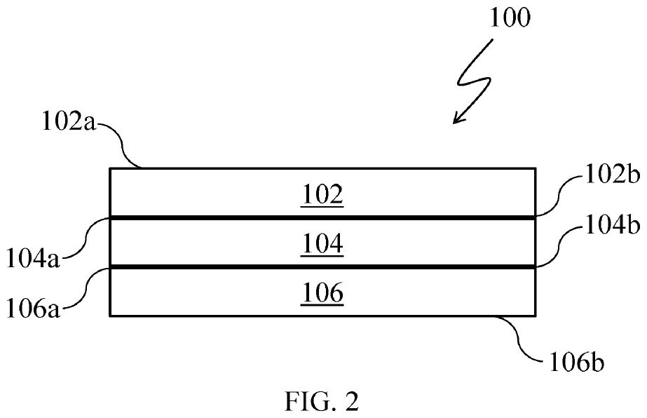

In some embodiments, the adhesive seam film may be part of a multilayer composite comprising two or more films. For example, referring now to FIG. 2, a multilayer composite is shown at 100. The multilayer composite 100 includes a first adhesive seam film 102, a second adhesive seam film 104, and a third adhesive seam film 106. Each of the first adhesive seam film 102, the second adhesive seam film 104, and the third adhesive seam film 106 have a first surface 102a, 104a, and 106a, respectively, and an opposing second surface 102b, 104b, and 106b, respectively. The opposing second surface 102b of the first adhesive seam film 102 may be bonded to the first surface 104a of the second adhesive seam film 104. The opposing second surface 104b of the second film 104 may be bonded to the first surface 106a of the third adhesive seam film 106.

At least one film in the multilayer composite may be an adhesive film composition as described herein. In some embodiments, all of the films in the multilayer composite are adhesive seam films. In some embodiments, each film in the multilayer composite has the same composition as the other films in the multilayer composite. In some embodiments, each film in the multilayer composite has a different composition as the other films in the multilayer composite. In some embodiments, some of the films in the multilayer composite have the same compositions and some the films in the multilayer composition have different compositions.

In some embodiments, one or more films in the multilayer composite may enhance a specific property of the multilayer composite. For example, one or more layers of the multilayer composite may decrease surface tack to enhance the ease of handling of the multilayer composite. In some embodiments, the adhesive seam film may comprise one or more outer layers of the multilayer composite. In some embodiments, the adhesive seam film may impart increased peel force to the multilayer composite. In some embodiments, the inner layer of film may comprise a thickness greater than the thickness of the adhesive seam film. In some embodiments, the inner layer of film may impart elasticity and elastic recovery to the multilayer composite.

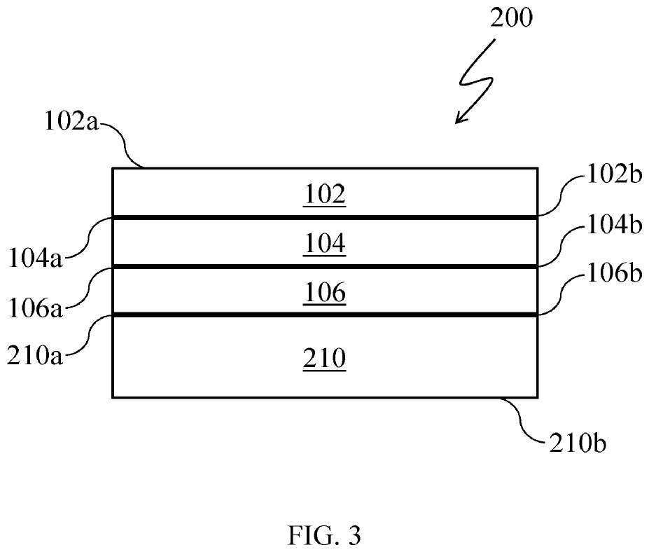

In some embodiments, the adhesive seam film may be part of a multilayer composite comprising the adhesive seam film adhered to a fabric backing. For example, referring now to FIG. 3, a multilayer composite with the adhesive seam film adhered to a fabric backing is shown at 200. The multilayer composite with the adhesive seam film adhered to a fabric backing 200 may include the first adhesive seam film 102, the second adhesive seam film 104, and the third adhesive seam film 106 as shown and described with respect to FIG. 2. The multilayer composite 200 further includes a fabric backing 210. The opposing second surface 106b of the third adhesive seam film 106 may be bonded to the first surface 210a of the fabric backing 210. The fabric back 210 may comprise nylon, polyester, acrylic, polyurethane, olefin, neoprene, acetate, elastane, or a combination thereof.

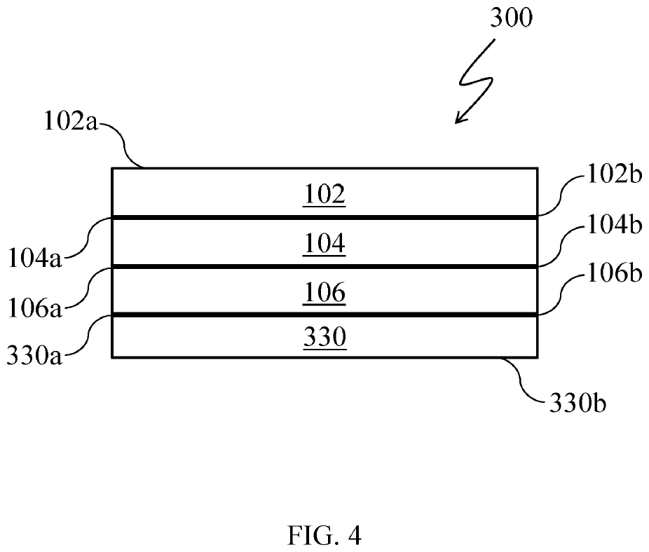

In some embodiments, the adhesive seam film may be part of a multilayer composite comprising the adhesive seam film adhered to a release liner. For example, referring now to FIG. 4, a multilayer composite comprising the adhesive seam film adhered to a release liner is shown at 300. The multilayer composite with the adhesive seam film adhered to a release liner 300 may include the first adhesive seam film 102, the second adhesive seam film 104, and the third adhesive seam film 106 as shown and described with respect to FIG. 2. The multilayer composite 300 further includes a release liner 330. The opposing second surface 106b of the third adhesive seam film 106 may be in contact with the first surface 330a of the release liner 330. In embodiments, the release liner 330 may comprise paper. The paper may be coated with a release material. The release material may decrease the force needed to remove the adhesive seam film from the release liner. The release material may comprise silicone.

In some embodiments, the release liner may be removable. In some embodiments, the multilayer composite comprising the adhesive seam film adhered to a release liner may comprise release liners on both surfaces of the multilayer composite. In some embodiments, the multilayer composite comprising the adhesive seam film adhered to a release liner may comprise a release liner on only one surface of the multilayer composite. In some embodiments, the release liner may be removed prior to using the multilayer composite.

In some embodiments, the adhesive seam film may be cut or slit to the desired width and then wound on a release liner as a roll. This roll may then be fed into an application machine and the application machine may then be used to apply the adhesive seam film onto fabric during apparel construction. The application machine may apply the adhesive seam film to fabric by unwinding the roll, bringing the adhesive seam film in to contact with the apparel, and removing and discarding the release liner.

### Method of Forming Adhesive Webbing

A method of forming an adhesive webbing may comprise preparing an adhesive webbing composition and extruding the adhesive composition to form a webbing that has a thickness of 25 μm to 30 μm. The adhesive webbing composition may comprise an adhesive composition according to one or more of the embodiments described herein

For example, the prepared adhesive webbing composition or components thereof may be fed into an extruder and melt-mixed at a temperature and for a time the same or similar to that described herein with respect to the method of forming an adhesive film.

The adhesive webbing composition may be extruded from the extruder.

As the adhesive composition is being extruded from the extruder, a die with multiple die holes at the end of the extruder may rotate and the adhesive composition may pass through these die holes as a filament on a traveling wire. The rotation of the die with multiple holes will cause the filaments to lay on top of each other and fuse together as a webbing.

### Adhesive Webbing

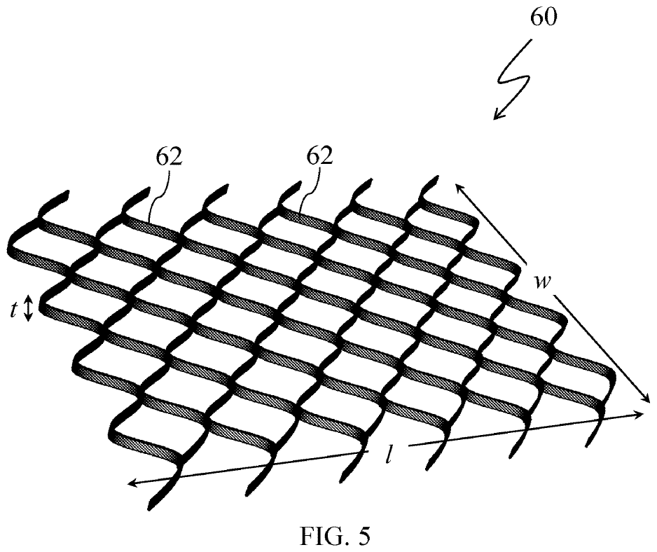

Referring now to FIG. 5, an adhesive webbing is shown at 60. The adhesive webbing 60 comprises a length l, a width w, and a thickness t. As shown in FIG. 5, adhesive webbing 60 comprise filaments 62 that may comprise the adhesive composition according to embodiments described and that are fused together to form the adhesive webbing 60. The adhesive webbing 60 may comprise the adhesive composition according to embodiments described herein.

The adhesive webbing 60 may have the same or similar thickness t and/or width w as described herein with respect to the adhesive film.

In embodiments, the use of an adhesive webbing may be desirable for applications where less fabric surface area needs to be bonded to an adhesive structure or applications where cost saving is desired.

In embodiments, similar to the adhesive film as described herein, the adhesive webbing 60 may be coated with a polymeric powder or dusting agent to ensure ease of manual handling. Examples of polymeric powders and dusting agents include powdered polyethylene and powdered polypropylene.

### Method of Preparing a Seam

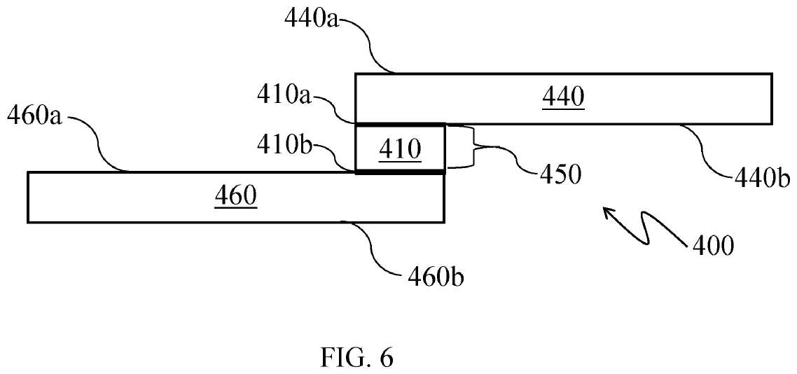

Referring now to FIG. 6, a method of preparing a seam comprises supplying a first section of fabric 440, a second section of fabric 460, and an adhesive seam film 410; situating the adhesive seam film 410 between the first section of fabric 440 and the second section of fabric 460 to form a seam section 450; and heating the seam section 450 such that the adhesive seam film 410 adheres the first section of fabric 440 and the second section of fabric 460. As shown in FIG. 6, the second section of fabric 460 at least partially overlaps the first section of fabric 440. These steps may be performed in sequence. The adhesive seam film 410 may comprise an adhesive film composition according to one or more of the embodiments described herein.

Heating the seam section 450 may be performed using a hot iron or hot air. The seam section 450 may be heated to a temperature greater than or equal to 100 °C, greater than or equal to 110 °C, or even greater than or equal to 120 °C. In embodiments, the seam section may be heated to a temperature less than or equal to 140 °C or even less than or equal to 130 °C. In embodiments, the seam section may be heated to a temperature from 100 °C to 140 °C, from 100 °C to 130 °C, from 110 °C to 140 °C, from 110 °C to 130 °C, from 120 °C to 140 °C, or even from 120 °C to 130 °C, or any and all sub-ranges formed from any of these endpoints. In some embodiments, the seam section 450 may be heated to the softening temperature of the adhesive film composition.

In embodiments, the seam section 450 may be compressed manually or by a compression machine. The seam section 450 may be compressed at a pressure of greater than or equal to 5 kilopascal (kPa), greater than or equal to 15 kPa, or even greater than or equal to 30 kPa. In embodiments, the seam section may be compressed at a pressure of less than or equal to 200 kPa, less than or equal to 100 kPa, or even less than or equal to 50 kPa. In embodiments, the seam section 450 may be heated to a temperature from 5 kPa to 200 kPa, from 5 kPa to 100 kPa, from 5 kPa to 50 kPa, from 15 kPa to 200 kPa, from 15 kPa to 100 kPa, from 15 kPa to 50 kPa, from 30 kPa to 200 kPa, from 30 kPa to 100 kPa, or even from 30 kPa to 50 kPa, or any and all sub-ranges formed from any of these endpoints.

### Seam

Referring again to FIG. 6, a seam is shown at 400. The seam 400 includes a first section of fabric 440, a second section of fabric 460, and an adhesive seam film 410. Each of the first section of fabric 440, the second section of fabric 460, and the adhesive seam film 410 have a first surface 440a, 460a, and 410a, respectively, and an opposing second surface 440b, 460b, and 410b, respectively. At least a portion of the opposing second surface 440b of the first section of fabric 440 may be bonded to the first surface 410a of the adhesive seam film 410. At least a portion of the first surface 460a of the second section of fabric 460 may be bonded to the opposing second surface 410b of the adhesive seam film 410. The adhesive seam film 410 is in the seam section 450. In embodiments, the adhesive layer 410 may be disposed between the first section of fabric 440 and the second section of fabric 460.

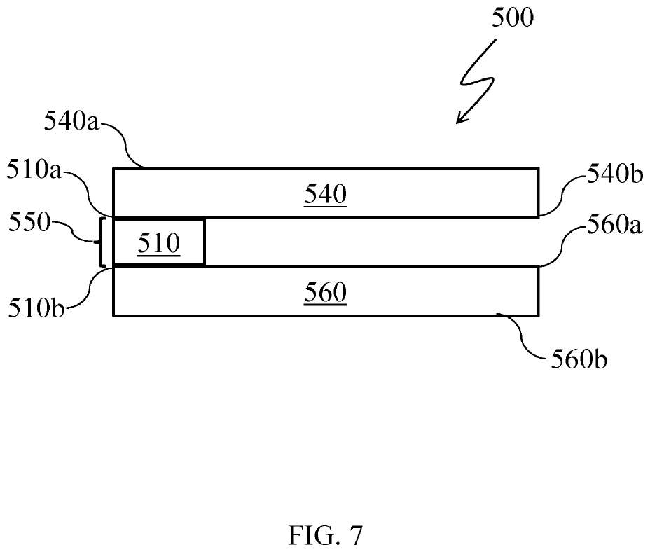

Referring now to FIG. 7, another seam is shown at 500, where the first section of fabric 540 fully overlaps the second section of fabric 560. The seam 500 includes a first section of fabric 540, a second section of fabric 560, and an adhesive seam film 510. Each of the first section of fabric 540, the second section of fabric 560, and the adhesive seam film 510 have a first surface 540a, 560a, and 510a, respectively, and an opposing second surface 540b, 560b, and 510b, respectively. At least a portion of the opposing second surface 540b of the first section of fabric 440 may be bonded to the first surface 510a of the adhesive seam film 510. At least a portion of the first surface 560a of the second section of fabric 560 may be bonded to the opposing second surface 510b of the adhesive seam film 510. The adhesive seam film 510 is in the seam section 550. In embodiments, as shown in FIG. 7 the adhesive layer 510 may extend partially along the length of the first and second sections of fabric 540, 560. In other embodiments, the adhesive layer 510 may extend along the entire length of the first and second sections of fabric 540, 560.

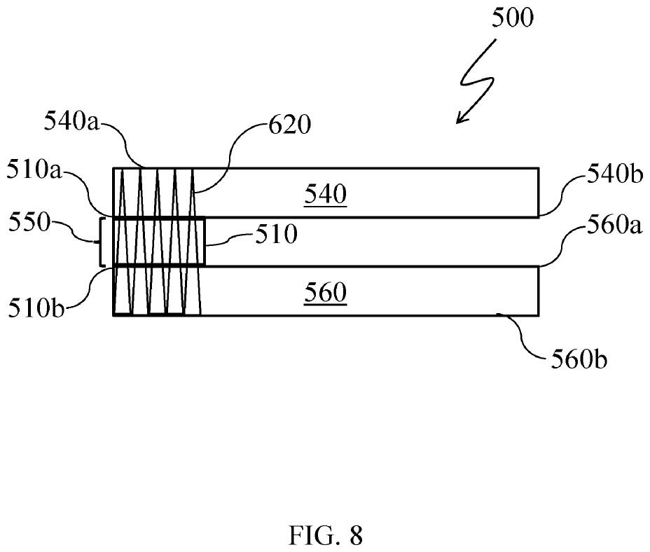

In some embodiments, the seam section may include stitches attaching the first section of fabric to the second section of fabric. For example, referring to FIG. 8, the seam section 550 may include stitches 620. In some embodiments, the seam section is a stitchless seam section, as shown in FIGS. 6 and 7.

The first and second sections of fabric of the seam may each comprise nylon, polyester, acrylic, polyurethane, olefin, neoprene, acetate, elastane, and combinations thereof. Examples of olefins include polypropylene polyethylene, and combinations thereof. Examples of neoprenes include polychloroprene. Examples of elastanes includes spandex. Examples of spandex include Lycra®, commercially available from DOW Chemical. In some embodiments, the first section of fabric and the second section of fabric may have the same compositions. In some embodiments, the first section of fabric and the second section of fabric may have different compositions.

In some embodiments, the multilayer composite comprising the adhesive seam film adhered to a fabric backing may be formed by extruding the film directly on to the fabric and bonding the adhesive seam film to the fabric to make the apparel waterproof. For example, waterproof apparel may be made by stitching or sewing with thread and then covering the holes created by the stitching or sewing with thread by bonding the holes and the surrounding fabric with the adhesive seam film.

### EXAMPLES

Non-limiting examples of various embodiments of the disclosed invention are provided.

Table 1 below shows sources of ingredients of adhesive film compositions of Comparative Example Adhesive Seam Films C1 to C3 and Example Adhesive Seam Films E1 and E2.

TABLE 1

| Ingredients | Brand | Source |
|---|---|---|
| styrene-ethylene/ | KRATON G1650 | Kraton |
| butylene-styrene | | |
| triblock copolymer | | |
| (bound styrene | | |
| content: 28-31 wt %) | | |
| styrene-ethylene/ | KRATON G1642 | Kraton |
| butylene-styrene | | |
| triblock copolymer | | |
| (bound styrene | | |
| content: 19-23 wt %) | | |
| white mineral oil | HYDROBRITE 380 | Sonneborn |
| tackifier | ESCOREZ 5300 | Exxon Mobile |
| tackifier | PLASTOLYN 290 | Eastman Chemical |

The formulations of Example Adhesive Seam Films E1 and E2 and Comparative Example Adhesive Seam Films C1-C3 were compounded in a twin screw extruder at a temperature of 165 °C to 205 °C. Pellets of the formulations of Example Adhesive Seam Films E1 and E2 and Comparative Example Adhesive Seam Films C1-C3 were then produced using a Brabender extruder with a film die attached to the end of the Brabender extruder at a temperature of 165 °C to 200 °C.

Example Adhesive Seam Films E1 and E2 and Comparative Example Adhesive Seam Films C1-C3 were situated between two layers of fabric and compressed at a pressure of 35 kPa for 15 seconds at 160 °C using a compression machine.

For the measurements, a cross section of Example Adhesive Seam Films E1 and E2 and Comparative Example Adhesive Seam Films C1-C3 were taken to normalize for differences in the resulting film thickness.

Table 2 below shows the formulations used to form and the certain properties of Example Adhesive Seam Films E1 and E2 and Comparative Example Adhesive Seam Films C1-C3.

TABLE 2

| | Example | | | | |
|---|---|---|---|---|---|
| | C1 | C2 | C3 | E1 | E2 |
| Ingredient | Wt % | Wt % | Wt % | Wt % | Wt % |
| KRATON G1650 | 49.0 | — | — | 45.5 | 45.0 |
| KRATON G1642 | — | 44.6 | 44.6 | — | — |
| HYDROBRITE 380 | 51.0 | 32.2 | 26.2 | 35.5 | 34.0 |
| ESCOREZ 5300 | — | — | 8.0 | 19.0 | 21.0 |
| PLASTOLYN 290 | — | 22.6 | 20.6 | — | — |
| Peel Force with 85 wt % | 1050 | 875 | 875 | 1400 | 1225 |
| polyester and 15 wt % | | | | | |
| spandex fabric (N/m) | | | | | |
| Load at 200% (kPa) | 345 | 1379 | 1241 | 310 | 310 |
| Hysteresis (%) | 5 | 8 | 10 | 0 | 0 |
| Melt Index at 175 °C | 10.8 | — | — | — | 19 |
| (g/10 min) | | | | | |
| Melt Index at 190 °C | — | 38 | 40 | 17 | — |
| (g/10 min) | | | | | |
| 50 μm film | Yes | No | No | Yes | Yes |

As exemplified in Table 2, the adhesive film compositions disclosed herein may be used to form adhesive seam films having desirable adhesion or bonding strength, elasticity, and/or elastic recovery.

As further exemplified in Table 2, the adhesive film compositions disclosed herein may be used to form thin adhesive seam films. While not wishing to be bound by theory, it is believed that the adhesive film compositions used to form Example Adhesive Seam Films E1 and E2 had the proper balance of the properties of the adhesive film composition and the quantities and properties of the individual components in the adhesive film composition to achieve the thin adhesive seam film. Furthermore, while not wishing to be bound theory, while Comparative Example Adhesive Seam Film C1, may have had the proper balance of properties and quantities to achieve a thin adhesive seam film, Comparative Example Adhesive Seam Film C1 may not achieve the adhesion or bonding strength, elasticity, and/or elastic recovery desirable in certain applications.

Every document cited herein is incorporated herein by reference in its entirety unless otherwise specified. The citation of any document is not to be construed as an admission that it is prior art with respect to any invention disclosed or claimed herein. To the extent that any meaning or definition of a term in this document conflicts with any meaning or definition of the same term in a document incorporated by reference, the meaning or definition assigned to that term in this document shall govern.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. An adhesive seam film comprising an adhesive film composition, the adhesive film composition comprising, based on the total weight of the adhesive film composition:
21 wt % to 85 wt % of a styrene-ethylene/butylene-styrene triblock copolymer, wherein the styrene-ethylene/butylene-styrene triblock copolymer has a weight average molecular weight of 90,000 g/mol to 140,000 g/mol and a bound styrene content of 28 wt % to 35 wt %, based on the total weight of the styrene-ethylene/butylene-styrene triblock copolymer;
15 wt % to 35.5 wt % of a white mineral oil; and
0 wt % to 40 wt % of a tackifier, wherein the tackifier has a weight average molecular weight of 500 g/mol to 5000 g/mol, a glass transition temperature of 50 °C to 100 °C, and a softening temperature of 100 °C to 140 °C;
wherein the adhesive seam film has a thickness of 25 μm to 250 μm.

2. The adhesive seam film of claim 1, wherein the adhesive film composition comprises 21 wt % to 55 wt % of the styrene-ethylene/butylene-styrene triblock copolymer, and 27 wt % to 35.5 wt % of a white mineral oil.

3. The adhesive seam film of claim 1, wherein the adhesive film composition comprises 5 wt % to 30 wt % of the tackifier.

4. The adhesive seam film of claim 1, wherein the tackifier is a midblock associating tackifier.

5. The adhesive seam film of claim 1, wherein the adhesive seam film has a width of 5 cm to 40 cm.

6. The adhesive seam film of claim 1, wherein the adhesive film composition has a melt index of 15 g/10 min to 60 g/10 min, as measured according to ASTM D1238 at 190 °C and under 2.16 kg load.

7. The adhesive seam film of a, claim 1, wherein the styrene-ethylene/butylene-styrene triblock copolymer has a polydispersity of 1.0 to 1.3.

8. The adhesive seam film of claim 1, wherein the adhesive seam film is part of a multilayer composite comprising two or more films.

9. The adhesive seam film of claim 1, wherein the adhesive seam film is part of a multilayer composite comprising the adhesive seam film adhered to a fabric backing.

10. (canceled)

11. (canceled)

12. The adhesive seam film of claim 1, wherein the adhesive seam film has a percent hysteresis less than 5%, as measured according to using a two cycle 200% stretch test.

13. The adhesive seam film of claim 1, wherein the adhesive seam film has a percent hysteresis less than 3%, as measured according to using a two cycle 200% stretch test.

14. The adhesive seam film of claim 1, wherein the adhesive film composition further includes a maleic anhydride grafted styrene-ethylene/butylene-styrene triblock copolymer.

15. A seam comprising:
a first section of fabric;
a second section of fabric at least partially overlapping the first section of fabric to form a seam section; and
the adhesive seam film of claim 1 located in the seam section adhering the first section of fabric to the second section of fabric.

16. The seam of claim 15, wherein the adhesive seam film is disposed between the first section of fabric and the second section of fabric.

17. The seam of claim 15, wherein the seam section includes stitches attaching the first section of fabric to the second section of fabric.

18. The seam of claim 15, wherein the seam section is a stitchless seam section.

19. The seam of claim 15, wherein the first section of fabric and the second section of fabric each comprise nylon, polyester, acrylic, polyurethane, olefin, neoprene, acetate, elastane, or a combination thereof.

20. A method of forming an adhesive seam film comprising:
preparing an adhesive film composition; and
extruding the adhesive film composition to form an adhesive seam film that has a thickness of 25 μm to 250 μm;
wherein the adhesive film composition comprises:
21 wt % to 85 wt % of a styrene-ethylene/butylene-styrene triblock copolymer based on the total weight of the film composition, wherein the styrene-ethylene/butylene-styrene triblock copolymer has a weight average molecular weight of 90,000 g/mol to 140,000 g/mol and a bound styrene content of 28% to 35% weight percent based on the total weight of the styrene-ethylene/butylene-styrene triblock copolymer;
15 wt % to 35.5 wt % of a white mineral oil; and
0 wt % to 40 wt % of a tackifier, wherein the tackifier has a weight average molecular weight of 500 g/mol to 5000 g/mol, a glass transition temperature of 50 °C to 100 °C, and a softening temperature of 100 °C to 140 °C.

21. (canceled)

22. A method of preparing a seam comprising:
supplying a first section of fabric, a second section of fabric, and an adhesive seam film;
situating the adhesive seam film between the first section of fabric and the second section of fabric to form a seam section, wherein the second section of fabric at least partially overlaps the first section of fabric; and
heating the seam section such that the adhesive seam film adheres the first section of fabric and the second section of fabric,
wherein the adhesive seam film compromises an adhesive film composition comprising, based on the total weight of the adhesive film composition:
21 wt % to 85 wt % of a styrene-ethylene/butylene-styrene triblock copolymer, wherein the styrene-ethylene/butylene-styrene triblock copolymer has a weight average molecular weight of 90,000 g/mol to 140,000 g/mol and a bound styrene content of 28 wt % to 35 wt %, based on the total weight of the styrene-ethylene/butylene-styrene triblock copolymer;
15 wt % to 35.5 wt % of a white mineral oil; and
0 wt % to 40 wt % of a tackifier, wherein the tackifier has a weight average molecular weight 500 g/mol to 5000 g/mol, a glass transition temperature 50 °C to 100 °C, and a softening temperature of 100 °C to 140 °C; and
wherein the adhesive seam film has a thickness of 25 μm to 250 μm.

23. The method of claim 22, wherein the adhesive film composition comprises 5 wt % to 30 wt % of the tackifier.

24-35. (canceled)
